(19) United States
(12) Patent Application Publication
(10) Pub. No.: US 2011/0261885 A1
(43) Pub. Date: Oct. 27, 2011

(54) METHOD AND SYSTEM FOR BANDWIDTH REDUCTION THROUGH INTEGRATION OF MOTION ESTIMATION AND MACROBLOCK ENCODING

(76) Inventor: Peter Francis Chevalley de Rivaz, Cambridgeshire (GB)

(21) Appl. No.: 12/787,054

(22) Filed: May 25, 2010

Related U.S. Application Data
(60) Provisional application No. 61/328,422, filed on Apr. 27, 2010.

(51) Int. Cl. H04N 7/32

(52) U.S. Cl. 375/240.16; 375/E07.104

(57) ABSTRACT

Video data for a current frame and a plurality of reference frames may be loaded into a video codec in a video processing device from a memory used in the video processing device, and the loaded video data may be buffered in an internal buffer used during motion estimation. Motion estimation may be performed based on the loaded video data, and after completion of the motion estimation, macroblock encoding for the current frame may be performed based on the loaded video data and the motion estimation. The motion estimation may comprise coarse motion estimation and fine motion estimation, and motion vectors may be generated based on the motion estimation on per-macroblock basis. The encoding may comprise macroblock encoding of a residual for the current frame, which may be determined based on the original video data, accessed from the internal motion estimation buffer, and prediction determined based on the generated motion vectors.

### CROSS-REFERENCE TO RELATED APPLICATIONS/INCORPORATION BY REFERENCE

This patent application makes reference to, claims priority to and claims benefit from U.S. Provisional Patent Application Ser. No. 61/328,422 filed on Apr. 27, 2010

This application makes reference to:
U.S. Patent Provisional Application Ser. No. 61/318,653 (Attorney Docket No. 21160US01) which was filed on Mar. 29, 2010;
U.S. Patent Provisional Application Ser. No. 61/287,269 (Attorney Docket No. 21161US01) which was filed on Dec. 17, 2009;
U.S. patent application Ser. No. 12/686,800 (Attorney Docket No. 21161US02) which was filed on Jan. 13, 2010;
U.S. Patent Provisional Application Ser. No. 61/311,640 (Attorney Docket No. 21162US01) which was filed on Mar. 8, 2010;
U.S. Patent Provisional Application Ser. No. 61/315,599 (Attorney Docket No. 21163US01) which was filed on Mar. 19, 2010;
U.S. Patent Provisional Application Ser. No. 61/320,179 (Attorney Docket No. 21165US01) which was filed on Apr. 1, 2010;
U.S. Patent Provisional Application Ser. No. 61/312,988 (Attorney Docket No. 21166US01) which was filed on Mar. 11, 2010;
U.S. Patent Provisional Application Ser. No. 61/323,078 (Attorney Docket No. 21168US01) which was filed on Apr. 12, 2010;

U.S. Patent Provisional Application Ser. No. (Attorney Docket No. 21169US01) which was filed on [actual date or “even date herewith”];
U.S. Patent Provisional Application Ser. No. 61/324,374 (Attorney Docket No. 21171US01) which was filed on Apr. 15, 2010;
U.S. Patent Provisional Application Ser. No. 61/321,244 (Attorney Docket No. 21172US01) which was filed on Apr. 6, 2010;
U.S. Patent Provisional Application Ser. No. 61/316,865 (Attorney Docket No. 21174US01) which was filed on Mar. 24, 2010;
U.S. Patent Provisional Application Ser. No. 61/319,971 (Attorney Docket No. 21175US01) which was filed on Apr. 1, 2010;
U.S. patent application Ser. No. 12/763,334 (Attorney Docket No. 21175US02) which was filed on Apr. 20, 2010;
U.S. Patent Provisional Application Ser. No. 61/315,620 (Attorney Docket No. 21176US01) which was filed on Mar. 19, 2010; and
U.S. Patent Provisional Application Ser. No. 61/315,637 (Attorney Docket No. 21177US01) which was filed on Mar. 19, 2010.

Each of the above stated applications is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to video processing. More specifically, certain embodiments of the invention relate to a method and system for bandwidth reduction through integration of motion estimation and macroblock encoding.

### BACKGROUND OF THE INVENTION

Image and video capabilities may be incorporated into a wide range of devices such as, for example, cellular phones, personal digital assistants, digital televisions, digital direct broadcast systems, digital recording devices, gaming consoles and the like. Operating on video data, however, may be very computationally intensive because of the large amounts of data that need to be constantly moved around. This normally requires systems with powerful processors, hardware accelerators, and/or substantial memory, particularly when video encoding is required. Such systems may typically use large amounts of power, which may make them less than suitable for certain applications, such as mobile applications. Due to the ever growing demand for image and video capabilities, there is a need for power-efficient, high-performance multimedia processors that may be used in a wide range of applications, including mobile applications. Such multimedia processors may support multiple operations including audio processing, image sensor processing, video recording, media playback, graphics, three-dimensional (3D) gaming, and/or other similar operations.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for bandwidth reduction through integration of motion estimation and macroblock encoding, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary multimedia system that is operable to provide memory bandwidth reduction during video encoding, in accordance with an embodiment of the invention.

FIG. 1B is a block diagram of an exemplary multimedia processor that is operable to provide memory bandwidth reduction during video encoding, in accordance with an embodiment of the invention.

FIG. 2 is a block diagram that illustrates an exemplary video processing core architecture that is operable to provide memory bandwidth reduction during video encoding, in accordance with an embodiment of the invention.

FIG. 3 is a block diagram that illustrates an exemplary hardware video accelerator comprising memory bandwidth reduction during video encoding, in accordance with an embodiment of the invention.

FIG. 4 is a flow chart that illustrates exemplary steps for bandwidth reduction through integration of motion estimation and macroblock encoding, in accordance with an embodiment of the invention.

### DETAILED DESCRIPTION OF THE INVENTION

Certain embodiments of the invention may be found in a method and system for bandwidth reduction through integration of motion estimation and macroblock encoding. Various embodiments of the invention comprise a video processing device which may comprise a video coder-decoder (codec) for performing motion-compensation based video encoding and/or decoding. Video data for a current frame and a plurality of reference frames may be loaded into the video codec from a memory used in the video processing device, and the loaded video data may be buffered in an internal buffer used during motion estimation. The motion estimation and/or the macroblock encoding may be performed to facilitate video encoding based on H.264/MPEG-4 AVC compression. The video codec may also perform video encoding and/or decoding based on VC-1, MPEG-1, MPEG-2, MPEG-4 and/or AVS standards. Furthermore, the video codec may perform video encoding and/or decoding based on one or more legacy video compression standards, comprising, for example, On2 V6/VP7 and/or H.263 standards. The motion estimation may be performed for the current frame based on the loaded video data, and after completion of the motion estimation, macroblock encoding for the current frame may be performed using the video data loaded into the internal buffer and output(s) of the motion estimation. In this regard, the motion estimation may comprise performing both coarse motion estimation (CME) and fine motion estimation (FME), and generation of motion vectors based on the motion estimation on per-macroblock basis. The encoding may comprise macroblock encoding of a residual of the current frame, wherein the residual may be determined based on the original video data, accessed from the internal buffer, and prediction determined based on the generated motion vectors. In this regard, the residual may be generated by subtracting from the original video data corresponding to the current frame the prediction generated based on the motion vectors generated from the motion estimation.

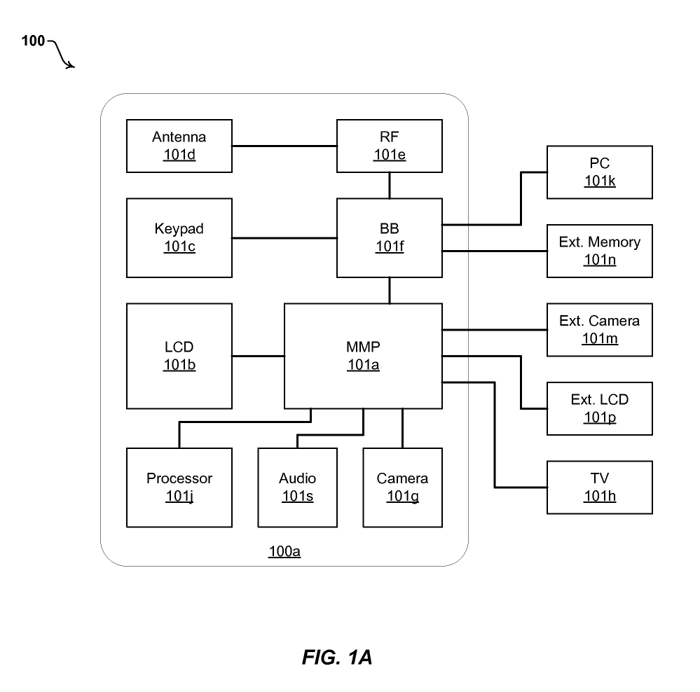

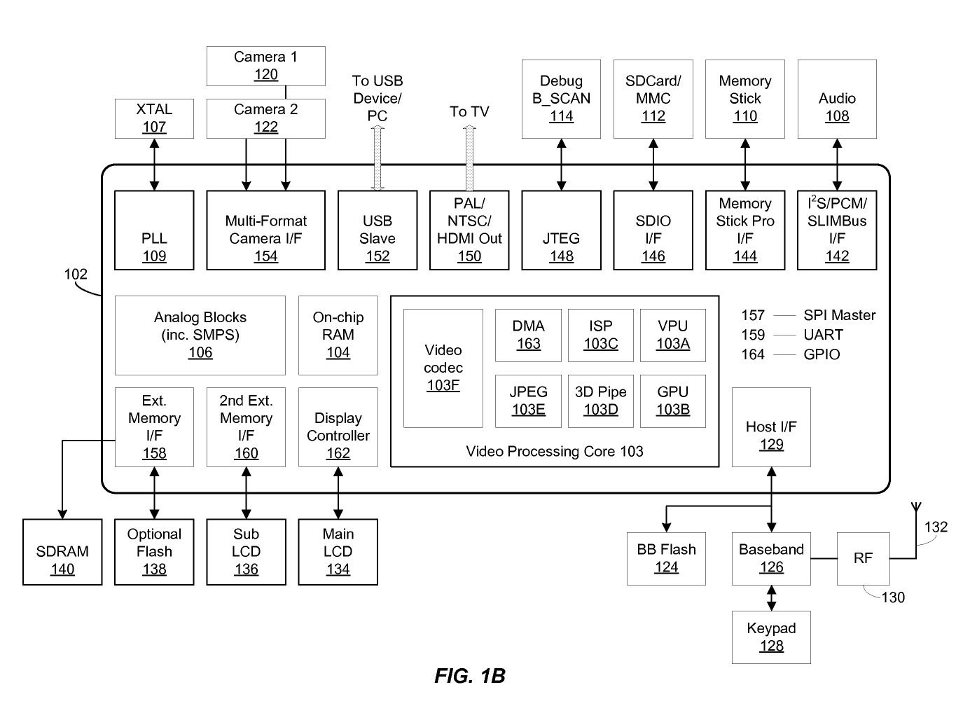

FIG. 1A is a block diagram of an exemplary multimedia system that is operable to provide memory bandwidth reduction during video encoding, in accordance with an embodiment of the invention. Referring to FIG. 1A, there is shown a mobile multimedia system 100 that comprises a mobile multimedia device 100a, a television (TV) 101h, a personal computer (PC) 101k, an external camera 101m, external memory 101n, and external liquid crystal display (LCD) 101p. The mobile multimedia device 100a may be a cellular telephone or other handheld communication device. The mobile multimedia device 100a may comprise a mobile multimedia processor (MMP) 101a, an antenna 101d, an audio block 101s, a radio frequency (RF) block 101e, a baseband processing (BB) block 101f, an LCD 101b, a keypad 101c, and a camera 101g.

The MMP 101a may comprise suitable circuitry, logic, interfaces, and/or code that may be operable to perform video and/or multimedia processing for the mobile multimedia device 100a. The MMP 101a may also comprise integrated interfaces, which may be utilized to support one or more external devices coupled to the mobile multimedia device 100a. For example, the MMP 101a may support connections to a TV 101h, an external camera 101m, and an external LCD 101p.

The processor 101j may comprise suitable circuitry, logic, interfaces, and/or code that may be operable to control processes in the mobile multimedia system 100. Although not shown in FIG. 1A, the processor 101j may be coupled to a plurality of devices in and/or coupled to the mobile multimedia system 100.

In operation, the mobile multimedia system 100 may capture, generate, and/or output multimedia streams and/or video data. The mobile multimedia system 100 may also transmit and/or receive messages corresponding to and/or comprising any such multimedia streams or video data. The video data may comprise a plurality of video frames, which correspond to plurality of still images and/or video streams. For example, the mobile multimedia device 100a may transmit and/or receive, via one or more wireless and/or wired connections, messages comprising multimedia streams and/or video data. In this regard, the multimedia streams and/or video data may be transmitted to and/or received from remote devices via the antenna 101d and/or the RF 101e. Multimedia and/or video data also be communicated within the mobile multimedia system 100, to and/or from one or more internal components of the mobile multimedia device 100a, such as, for example, the LCD 101b and/or the camera 101g; and/or one or more external devices coupled to the mobile multimedia device 100a, such as, for example, the PC 101k, the TV 101h, the external camera 101m, and/or the external LCD 101p.

The MMP 101c may process video and/or multimedia data corresponding to multimedia streams and/or still images displayed, played, and/or generated by the mobile multimedia system 100. In this regard, processing video and/or multimedia data in the mobile multimedia system 100 may comprise performing video encoding and/or decoding based on one or more video compression standards supported by the mobile multimedia system 100. For example, multimedia and/or video data generated and/or consumed by the mobile multimedia system 100 may be encoded and/or decoded based on one or more video compression standards, via the MMP 101c for example, such as AVS, H.264, MPEG-4, MPEG-2, MPEG-1, and/or Windows Media 8/9/10 (VC-1). The mobile multimedia system 100 may also support video codec operations based on one or more legacy video compression standards, such as, for example, RealVideo 9/10, On2 VP6/VP7, Sorenson Spark, and/or H.263 (Profiles 0 and 3).

In an exemplary aspect of the invention, various procedures and/or techniques may be implemented in the mobile multimedia system 100 for improving memory use and/or reducing memory access bandwidth during video processing operations. In this regard, a commonly shared memory, such as the external memory 101n for example, may be utilized for storing data used and/or created during video and/or multimedia processing operations in the mobile multimedia system 100. For example, in instances where the mobile multimedia system 100 is utilized to generate and/or capture multimedia streams and/or still images, using the camera 101g and/or the external camera 101m for example, corresponding generated data may be stored in the external memory 101n. The stored data may be accessed multiple times during at least some video compression related processing. For example, during H.264 encoding, which utilizes motion-compensation based block encoding scheme, video data that is to be encoded may be first fetched for motion compensation related processing, to generate motion estimation related information. Motion compensation is a technique that may be used during video compression to reduce the size corresponding encoded video data. Use of motion compensation exploits the fact that in many video streams, only minimal differences and/or changes may exist between images in various sequences, resulting, mainly, from movement of the capturing device and/or one or more objects in the image. In this regard, images may refer to full frames in progressive video or to fields in interlaced video. According, motion compensation may be utilized to define an image, or parts thereof, during video encoding operations in terms of differences transformation (i.e. changes) from one or more reference images to the current image, thus obviating the need to encode the whole current image. Exemplary uses of motion compensation techniques may be found in the use of inter-frames (i.e. use of I-frames, P-frames, and/or B-frames) in MPEG based compression.

Once motion compensation related processing is complete, the video data may then be fetched from memory a second time to perform macroblock encoding, based on, for example, the generated motion estimation information. The repeated fetching of the same video data may increase memory access bandwidth in the mobile multimedia system 100, and/or may necessitate longer durations for storage of encoded/decoded video data. Accordingly, in various embodiments of the invention, operations of various components of the mobile multimedia system 100, which are utilized during video processing operations, may be modified to reduce memory use requirement and/or to reduce memory access bandwidth. In this regard, video data may be fetched only once, for example, and buffered internally within the components during various at least some of the stages and/or steps performed in the course of video encoding and/or decoding operations.

FIG. 1B is a block diagram of an exemplary multimedia processor that is operable to provide memory bandwidth reduction during video encoding, in accordance with an embodiment of the invention. Referring to FIG. 1B, there is shown a mobile multimedia processor 102, which may correspond to the MMP 101a of FIG. 1A. In this regard, the mobile multimedia processor 102 may comprise suitable logic, circuitry, interfaces, and/or code that may be operable to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise a video processing core 103 that may comprise a graphic processing unit (GPU) 103B, an image sensor pipeline (ISP) 103C, a 3D pipeline 103D, a direct memory access (DMA) controller 163, a Joint Photographic Experts Group (JPEG) encoding/decoding module 103E, and a video encoding/decoding module 103F. The mobile multimedia processor 102 may also comprise on-chip RAM 104, an analog block 106, a phase-locked loop (PLL) 109, an audio interface (I/F) 142, a memory stick I/F 144, a Secure Digital input/output (SDIO) I/F 146, a Joint Test Action Group (JTAG) I/F 148, a TV output I/F 150, a Universal Serial Bus (USB) I/F 152, a camera I/F 154, and a host I/F 129. The mobile multimedia processor 102 may further comprise a serial peripheral interface (SPI) 157, a universal asynchronous receiver/transmitter (UART) I/F 159, a general purpose input/output (GPIO) pins 164, a display controller 162, an external memory I/F 158, and a second external memory I/F 160.

The video processing core 103 may comprise suitable logic, circuitry, interfaces, and/or code that may be operable to perform video processing of data. The on-chip Random Access Memory (RAM) 104 and the Synchronous Dynamic RAM

(SDRAM) 140 comprise suitable logic, circuitry and/or code that may be adapted to store data such as image or video data. The GPU 103B may comprise suitable logic, circuitry, interfaces, and/or code that may be operable to offload graphics rendering from a general processor, such as the processor 101j, described with respect to FIG. 1A. The GPU 103B may be operable to perform mathematical operations specific to graphics processing, such as texture mapping and rendering polygons, for example. The image sensor pipeline (ISP) 103C may comprise suitable circuitry, logic and/or code that may be operable to process image data. The ISP 103C may perform a plurality of processing techniques comprising filtering, demosaic, lens shading correction, defective pixel correction, white balance, image compensation, Bayer interpolation, color transformation, and post filtering, for example. The processing of image data may be performed on variable sized tiles, reducing the memory requirements of the ISP 103C processes.

The 3D pipeline 103D may comprise suitable circuitry, logic and/or code that may enable the rendering of 2D and 3D graphics. The 3D pipeline 103D may perform a plurality of processing techniques comprising vertex processing, rasterizing, early-Z culling, interpolation, texture lookups, pixel shading, depth test, stencil operations and color blend, for example. The 3D pipeline 103D may comprise one or more shader processors that may be operable to perform rendering operations. The shader processors may be closely-coupled with peripheral devices to perform such rendering operations. The JPEG module 103E may comprise suitable logic, circuitry, interfaces, and/or code that may be operable to encode and/or decode JPEG images. JPEG processing may enable compressed storage of images without significant reduction in quality. The video encoding/decoding module 103F may comprise suitable logic, circuitry, interfaces, and/or code that may be operable to encode and/or decode images, such as generating full 1080p HD video from H.264 compressed data, for example. In addition, the video encoding/decoding module 103F may be operable to generate standard definition (SD) output signals, such as phase alternating line (PAL) and/or national television system committee (NTSC) formats.

Also shown in FIG. 1B are an audio block 108 that may be coupled to the audio interface I/F 142, a memory stick 110 that may be coupled to the memory stick I/F 144, an SD card block 112 that may be coupled to the SDIO IF 146, and a debug block 114 that may be coupled to the JTAG I/F 148. The PAL/NTSC/high definition multimedia interface (HDMI) TV output I/F 150 may be utilized for communication with a TV, and the USB 1.1, or other variant thereof, slave port I/F 152 may be utilized for communications with a PC, for example. A crystal oscillator (XTAL) 107 may be coupled to the PLL 109. Moreover, cameras 120 and/or 122 may be coupled to the camera I/F 154.

Also shown in FIG. 1B are a baseband processing block 126 that may be coupled to the host interface 129, a radio frequency (RF) processing block 130 coupled to the baseband processing block 126 and an antenna 132, a baseband flash 124 that may be coupled to the host interface 129, and a keypad 128 coupled to the baseband processing block 126. A main LCD 134 may be coupled to the mobile multimedia processor 102 via the display controller 162 and/or via the second external memory interface 160, for example, and a subsidiary LCD 136 may also be coupled to the mobile multimedia processor 102 via the second external memory interface 160, for example. Moreover, an optional flash memory 138 and/or an SDRAM 140 may be coupled to the external memory I/F 158.

In operation, the mobile multimedia processor 102 may be adapted to receive images and/or video, which may be generated and/or captured via the cameras 120 and/or 122 for example, and to process the images and/or video, via the video processing core 103, for example, using the ISP 103C, the 3D pipeline 103D, and/or the video encoding/decoding module 103F. In this regard, the video processing core 103 may be operable to perform video encoding/decoding operations (codec) based on one or more video compression standards, such as H.264 and/or MPEG-4 formats.

In an exemplary aspect of the invention, the mobile multimedia processor 102 may implement and/or utilize various procedures and/or techniques to reduce memory access bandwidth and/or to make memory/storage use more efficient during video processing operations. For example, a commonly shared memory used to support operations of the mobile multimedia processor 102, comprising, for example, the on-chip RAM 104, the SDRAM 140, and/or the optional flash memory 138, may be utilized for storing data used, for example, during video and/or multimedia processing operations in the mobile multimedia processor 102. The commonly shared memory may be accessed using one or more buses and/or interfaces in the mobile multimedia processor 102. Accordingly, memory use and/or operations in the mobile multimedia processor 102 may be optimized by reducing duration and/or size of data stored, size of data transferred between the memory/storage components and processing components, and/or number of memory accesses performed during processing of any specific chunk of stored data. For example, in instances where the mobile multimedia processor 102 is used to generate and/or capture multimedia streams and/or still images, using the cameras 120 and/or 122, corresponding generated data may be stored in the on-chip RAM 104 and/or the SDRAM 140. Accordingly, to reduce memory access bandwidth and/or storage requirement during H.264 encoding, motion compensation and macroblock encoding may be integrated to enable fetching video data that is to be encoded only once rather than having to fetch the video data twice, once of each of the motion compensation related processing and the macroblock encoding.

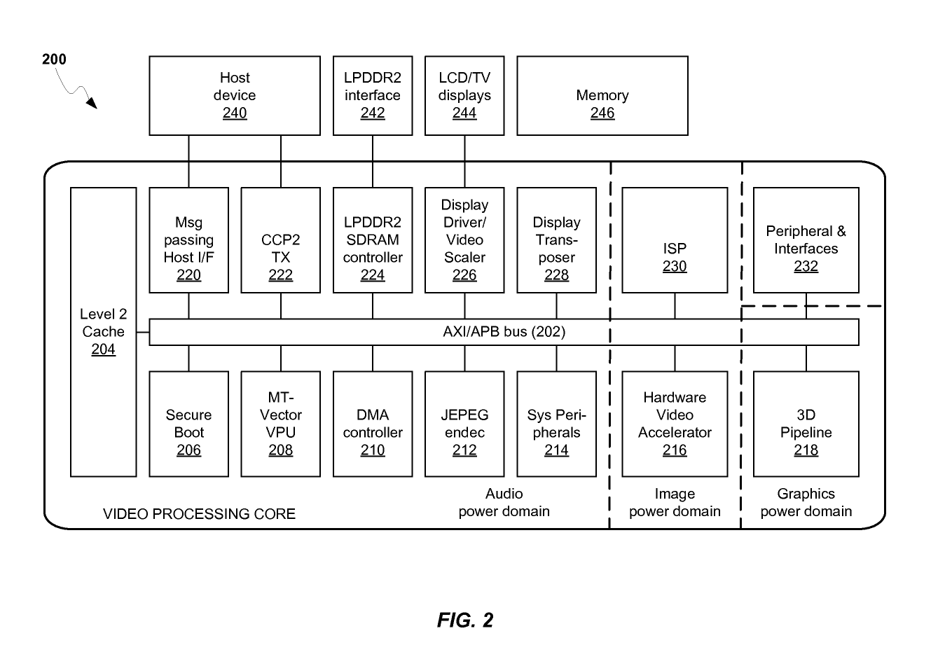

FIG. 2 is a block diagram that illustrates an exemplary video processing core architecture that is operable to provide memory bandwidth reduction during video encoding, in accordance with an embodiment of the invention. Referring to FIG. 2, there is shown a video processing core 200 comprising suitable logic, circuitry, interfaces and/or code that may be operable for high performance video and multimedia processing. The architecture of the video processing core 200 may provide a flexible, low power, and high performance multimedia solution for a wide range of applications, including mobile applications, for example. By using dedicated hardware pipelines in the architecture of the video processing core 200, such low power consumption and high performance goals may be achieved. The video processing core 200 may correspond to, for example, the video processing core 103 described above with respect to FIG. 1B.

The video processing core 200 may support multiple capabilities, including image sensor processing, high rate (e.g., 30 frames-per-second) high definition (e.g., 1080p) video encoding and decoding, 3D graphics, high speed JPEG encode and decode, audio codecs, image scaling, and/or LCD an TV outputs, for example.

In one embodiment, the video processing core 200 may comprise an Advanced eXtensible Interface/Advanced Peripheral (AXI/APB) bus 202, a level 2 cache 204, a secure boot 206, a Vector Processing Unit (VPU) 208, a DMA controller 210, a JPEG encoder/decoder (endec) 212, a systems peripherals 214, a message passing host interface 220, a Compact Camera Port 2 (CCP2) transmitter (TX) 222, a Low-Power Double-Data-Rate 2 SDRAM (LPDDR2 SDRAM) controller 224, a display driver and video scaler 226, and a display transposer 228. The video processing core 200 may also comprise an ISP 230, a hardware video accelerator 216, a 3D pipeline 218, and peripherals and interfaces 232. In other embodiments of the video processing core 200, however, fewer or more components than those described above may be included.

In one embodiment, the VPU 208, the ISP 230, the 3D pipeline 218, the JPEG endec 212, the DMA controller 210, and/or the hardware video accelerator 216, may correspond to the VPU 103A, the ISP 103C, the 3D pipeline 103D, the JPEG 103E, the DMA 163, and/or the video encode/decode 103F, respectively, described above with respect to FIG. 1B.

Operably coupled to the video processing core 200 may be a host device 240, an LPDDR2 interface 242, a LCD/TV display 244, and/or a memory 246. The host device 240 may comprise a processor, such as a microprocessor or Central Processing Unit (CPU), microcontroller, Digital Signal Processor (DSP), or other like processor, for example. In some embodiments, the host device 240 may correspond to the processor 101j described above with respect to FIG. 1A. The LPDDR2 interface 242 may comprise suitable logic, circuitry, and/or code that may be operable to allow communication between the LPDDR2 SDRAM controller 224 and memory. The LCD/TV displays 244 may comprise one or more displays (e.g., panels, monitors, screens, cathode-ray tubes (CRTs)) for displaying image and/or video information. In some embodiments, the LCD/TV displays 244 may correspond to one or more of the TV 101h and the external LCD 101p described above with respect to FIG. 1A, and the main LCD 134 and the sub LCD 136 described above with respect to FIG. 1B. The memory 246 may comprise suitable logic, circuitry, interfaces and/or code that enable permanent and/or non-permanent storage and/or fetch of data, code and/or other information used by the video processing core 200. In this regard, the memory 246 may comprise different memory technologies, including, for example, read-only memory (ROM), random access memory (RAM), and/or Flash memory. For example, the memory 246 may correspond to the RAM 104, the SDRAM 140, and/or the optional flash 138 of FIG. 1B. The memory 246 may be operable to store, for example, data resulting from video and/or image generation and/or capture operations supported by the video processing core 200.

The message passing host interface 220 and the CCP2 TX 222 may comprise suitable logic, circuitry, and/or code that may be operable to allow data and/or instructions to be communicated between the host device 240 and one or more components in the video processing core 200. The data communicated may include image and/or video data, for example.

The LPDDR2 SDRAM controller 224 and the DMA controller 210 may comprise suitable logic, circuitry, and/or code that may be operable to control the access of memory by one or more components and/or processing blocks in the video processing core 200.

The VPU 208 may comprise suitable logic, circuitry, and/or code that may be operable for data processing while maintaining high throughput and low power consumption. The VPU 208 may allow flexibility in the video processing core 200 such that software routines, for example, may be inserted into the processing pipeline. The VPU 208 may comprise dual scalar cores and a vector core, for example. The dual scalar cores may use a Reduced Instruction Set Computer (RISC)-style scalar instruction set and the vector core may use a vector instruction set, for example. Scalar and vector instructions may be executed in parallel.

Although not shown in FIG. 2, the VPU 208 may comprise one or more Arithmetic Logic Units (ALUs), a scalar data bus, a scalar register file, one or more Pixel-Processing Units (PPUs) for vector operations, a vector data bus, a vector register file, a Scalar Result Unit (SRU) that may operate on one or more PPU outputs to generate a value that may be provided to a scalar core. Moreover, the VPU 208 may comprise its own independent level 1 instruction and data cache.

The ISP 230 may comprise suitable logic, circuitry, and/or code that may be operable to provide hardware accelerated processing of data received from an image sensor (e.g., charge-coupled device (CCD) sensor, complimentary metal-oxide semiconductor (CMOS) sensor). The ISP 230 may comprise multiple sensor processing stages in hardware, including demosaicing, geometric distortion correction, color conversion, denoising, and/or sharpening, for example. The ISP 230 may comprise a programmable pipeline structure. Because of the close operation that may occur between the VPU 208 and the ISP 230, software algorithms may be inserted into the pipeline.

The hardware video accelerator 216 may comprise suitable logic, circuitry, and/or code that may be operable for hardware accelerated processing of video data in any one of multiple video formats such as H.264, Windows Media 8/9/10 (VC-1), MPEG-1, MPEG-2, and MPEG-4, for example. In this regard, the hardware video accelerator 216 may provide video coding/decoding (codec) functionality in the video processing core 200. The hardware video accelerator 216 may also be operable to support video codec operations based on one or more legacy video compression formats, such as, for example, On2 VP6/VP7 and/or H.263 standards. For H.264, for example, the hardware video accelerator 216 may encode at full HD 1080p at 30 frames-per-second (fps). For MPEG-4, for example, the hardware video acceleration 216 may encode a HD 720p at 30 fps. For H.264, VC-1, MPEG-1, MPEG-2, and MPEG-4, for example, the hardware video accelerator 216 may decode at full HD 1080p at 30 fps or better. The hardware video accelerator 216 may be operable to provide concurrent encoding and decoding for video conferencing and/or to provide concurrent decoding of two video streams for picture-in-picture applications, for example. In an exemplary aspect of the invention, the hardware video accelerator 216 may support, implement, and/or utilize various procedures for improving memory use and/or reducing memory access bandwidth in the video processing core 200. In this regard, in instances where the hardware video accelerator 216 is used to perform H.264 encoding, motion compensation and macroblock encoding may be integrated, substantially as described with regard to FIGS. 1A and 1B, to reduce the number of memory fetches and/or size of data fetched from memory used for common storage in the video processing core 200.

The 3D pipeline 218 may comprise suitable logic, circuitry, and/or code that may be operable to provide 3D rendering operations for use in, for example, graphics applications. The 3D pipeline 218 may support OpenGL-ES 2.0, OpenGL-ES 1.1, and OpenVG 1.1, for example. The 3D pipeline 218 may comprise a multi-core programmable pixel shader, for example. The 3D pipeline 218 may be operable to handle 32M triangles-per-second (16M rendered triangles-per-second), for example. The 3D pipeline 218 may be operable to handle 1 G rendered pixels-per-second with Gouraud shading and one bi-linear filtered texture, for example. The 3D pipeline 218 may support four times (4×) full-screen anti-aliasing at full pixel rate, for example. The 3D pipeline 218 may comprise a tile mode architecture in which a rendering operation may be separated into a first phase and a second phase. During the first phase, the 3D pipeline 218 may utilize a coordinate shader to perform a binning operation. During the second phase, the 3D pipeline 218 may utilize a vertex shader to render images such as those in frames in a video sequence, for example. Furthermore, the 3D pipeline 218 may comprise one or more shader processors that may be operable to perform rendering operations. The shader processors may be closely-coupled with peripheral devices to perform instructions and/or operations associated with such rendering operations.

The JPEG endec 212 may comprise suitable logic, circuitry, and/or code that may be operable to provide processing (e.g., encoding, decoding) of images. The encoding and decoding operations need not operate at the same rate. For example, the encoding may operate at 120M pixels-per-second and the decoding may operate at 50M pixels-per-second depending on the image compression.

The display driver and video scaler 226 may comprise suitable logic, circuitry, and/or code that may be operable to drive the TV and/or LCD displays in the TV/LCD displays 244. In this regard, the display driver and video scaler 226 may output to the TV and LCD displays concurrently and in real time, for example. Moreover, the display driver and video scaler 226 may comprise suitable logic, circuitry, and/or code that may be operable to scale, transform, and/or compose multiple images. The display driver and video scaler 226 may support displays of up to full HD 1080p at 60 fps. The display transposer 228 may comprise suitable logic, circuitry, and/or code that may be operable for transposing output frames from the display driver and video scaler 226. The display transposer 228 may be operable to convert video to 3D texture format and/or to write back to memory to allow processed images to be stored and saved.

The secure boot 206 may comprise suitable logic, circuitry, and/or code that may be operable to provide security and Digital Rights Management (DRM) support. The secure boot 206 may comprise a boot Read Only Memory (ROM) that may be used to provide secure root of trust. The secure boot 206 may comprise a secure random or pseudo-random number generator and/or secure (One-Time Password) OTP key or other secure key storage.

The AXI/APB bus 202 may comprise suitable logic, circuitry, and/or interface that may be operable to provide data and/or signal transfer between various components of the video processing core 200. In the example shown in FIG. 2, the AXI/APB bus 202 may be operable to provide communication between two or more of the components the video processing core 200. Furthermore, the AXI/APB bus 202 may also be utilized by various components in the video processing core 200 for accessing data stored in a memory external to the video processing core 200, such as the memory 246.

The AXI/APB bus 202 may comprise one or more buses. For example, the AXI/APB bus 202 may comprise one or more AXI-based buses and/or one or more APB-based buses. The AXI-based buses may be operable for cached and/or uncached transfer, and/or for fast peripheral transfer. The APB-based buses may be operable for slow peripheral transfer, for example. The transfer associated with the AXI/APB bus 202 may be of data and/or instructions, for example. The AXI/APB bus 202 may provide a high performance system interconnection that allows the VPU 208 and other components of the video processing core 200 to communicate efficiently with each other and with external memory, such as the memory 246.

The level 2 cache 204 may comprise suitable logic, circuitry, and/or code that may be operable to provide caching operations in the video processing core 200. The level 2 cache 204 may be operable to support caching operations for one or more of the components of the video processing core 200. The level 2 cache 204 may complement level 1 cache and/or local memories in any one of the components of the video processing core 200. For example, when the VPU 208 comprises its own level 1 cache, the level 2 cache 204 may be used as complement. The level 2 cache 204 may comprise one or more blocks of memory. In one embodiment, the level 2 cache 204 may be a 128 kilobyte four-way set associate cache comprising four blocks of memory (e.g., Static RAM (SRAM)) of 32 kilobytes each.

The system peripherals 214 may comprise suitable logic, circuitry, and/or code that may be operable to support applications such as, for example, audio, image, and/or video applications. In one embodiment, the system peripherals 214 may be operable to generate a random or pseudo-random number, for example. The capabilities and/or operations provided by the peripherals and interfaces 232 may be device or application specific.

In operation, video processing core 200 may be operable to perform various processing operations during capture, generate, and/or play back of multimedia and/or video data. The video processing core 200 may be operable to carry out multiple multimedia tasks simultaneously without degrading individual function performance. The 3D pipeline 218 may be operable to provide 3D rendering, such as tile-based rendering, for example, that may comprise a first or binning phase and a second or rendering phase. In this regard, the 3D pipeline 218 and/or other components of the video processing core 200 that are used to provide 3D rendering operations may be referred to as a tile-mode renderer. The 3D pipeline 218 may comprise one or more shader processors that may be operable with closely-coupled peripheral devices to perform instructions and/or operations associated with such rendering operations.

The video processing core 200 may also be operable to implement movie playback operations. In this regard, the video processing core 200 may be operable to add 3D effects to video output, for example, to map the video onto 3D surfaces or to mix 3D animation with the video. In another exemplary embodiment of the invention, the video processing core 200 may be utilized in a gaming device. In this regard, full 3D functionality may be utilized. The VPU 208 may be operable to execute a game engine and may supply graphics primitives (e.g., polygons) to the 3D pipeline 218 to enable high quality self-hosted games. In another embodiment, the video processing core 200 may be utilized for stills capture. In this regard, the ISP 230 and/or the JPEG endec 212 may be utilized to capture and encode a still image. For stills viewing and/or editing, the JPEG endec 212 may be utilized to decode the stills data and the video scaler may be utilized for display formatting. Moreover, the 3D pipeline 218 may be utilized for 3D effects, for example, for warping an image or for page turning transitions in a slide show, for example.

In an exemplary aspect of the invention, the video processing core 200 may implement and/or utilize various features and/or procedures to improve memory use and/or to reduce memory access bandwidth, via the AXI/APB bus 202 for example, in the video processing core 200. For example, one or more components of the video processing core 200 may fetch, via the AXI/APB bus 202 for example, data needed for performing their operations, such as video data corresponding to captured and/or generated images, which may be stored in the memory 246 for example. Accordingly, to reduce storage requirements and/or memory access bandwidth, the number of data transfers performed via the AXI/APB bus 202 may be reduced by buffering, for example, some of the used data internally within components of the video processing core 200. Furthermore, because used data are buffered internally within components of the video processing core 200, the duration of data storage required from the memory 246 may be reduced allowing for smaller storage therein.

In various embodiments of the invention, the hardware video accelerator 216 may implement and/or utilize various features and/or procedures to improve memory use and/or memory access bandwidth in the video processing core 200. For example, in instances where the hardware video accelerator 216 is used to perform H.264 encoding, video data corresponding to images that are to be encoded may be loaded from commonly shared memory, via the AXI/APB bus 202 for example, for performing an initial step in the overall H.264 encoding, such as motion estimation. The loaded video data may be buffered internally within the hardware accelerator 216, and may subsequently be used to complete the H.264 encoding, during macroblock encoding for example.

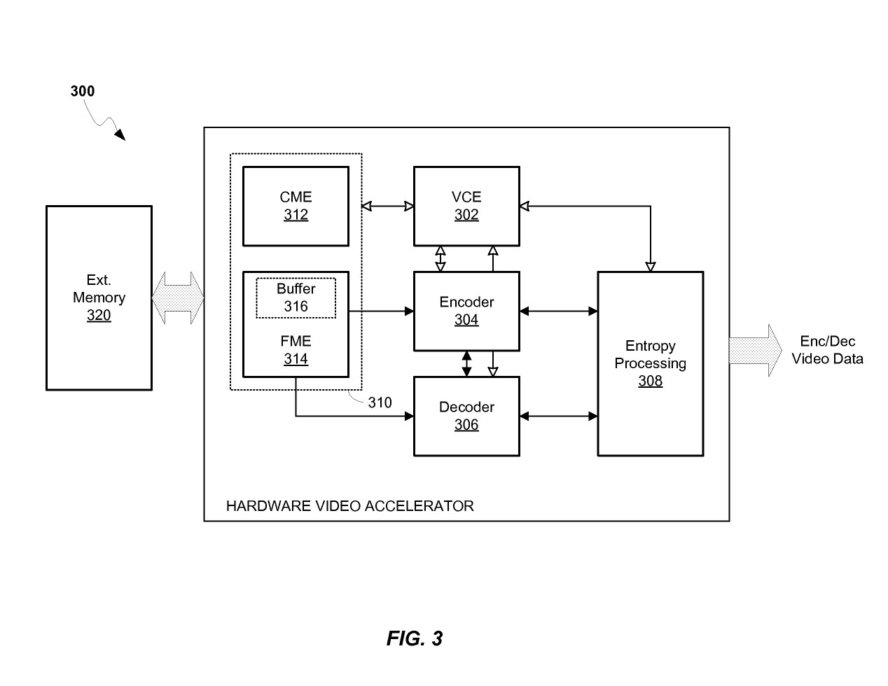

FIG. 3 is a block diagram that illustrates an exemplary hardware video accelerator comprising memory bandwidth reduction during video encoding, in accordance with an embodiment of the invention. Referring to FIG. 3, there is shown a hardware video accelerator 300 comprising suitable logic, circuitry, interfaces and/or code that may perform hardware accelerated processing of video data, comprising video compression/decompression (codec), based on one or more video formats such as H.264, Windows Media 8/9/10 (VC-1), MPEG-1, MPEG-2, and MPEG-4, for example. The hardware video accelerator 300 may also be operable to performing video coding/decoding based on one or more legacy video formats, such as RealVideo 9/10, On2 VP6/VP7, Sorenson Spark, H.263 (Profiles 0 and 3). The hardware video accelerator 300 may provide, for example, H.263 encoding/decoding at 30 fps up to WVGA resolution (800×480). The hardware video accelerator 300 may correspond to, for example, the hardware video accelerator 216 described above with respect to FIG. 2. The hardware video accelerator 300 may comprise, for example, a video control engine (VCE) module 302, an encoder module 304, a decoder module 306, an entropy processing module 308, and a motion estimation module 310, which may comprise a coarse motion estimation (CME) module 312 and a fine motion estimation (FME) module 314.

Also shown in FIG. 3 is memory 320, which may be external to the hardware video accelerator 300, and which may be utilized for storage of data processed by the hardware video accelerator 300. In this regard, the memory 320 may correspond to the memory 246 and/or the level-2 cache 204 described above with respect to FIG. 2.

The VCE module 302 may comprise suitable logic, circuitry, interfaces and/or code that may be operable to control and/or manage operations of the hardware video accelerator 300. In this regard, the VCE module 302 may be operable to configure and/or control operations of various components and/or subsystems of the hardware video accelerator 300, by providing, for example, control signals. The VCE module 302 may also control data transfers within the hardware video accelerator 300, during video encoding/decoding processing operations for example. The VCE module 302 may enable execution of applications, programs and/or code, which may be stored internally in the hardware video accelerator 300 in the form of firmware and/or software, for example.

The encoder module 304 may comprise suitable logic, circuitry, interfaces and/or code that may be operable to encode video data, corresponding to locally generated and/or captured images for example, based on one or more video compression formats supported by the hardware video accelerator 300. For example, the encoder module 304 may be used, in conjunction with other components of the hardware video accelerator 300 such as the motion estimation module 310 and/or the entropy processing module 308, to perform H.264 encoding.

The decoder module 306 may comprise suitable logic, circuitry, interfaces and/or code that may be operable to decode video data, corresponding to received multimedia streams and/or still images for example, based on one or more video compression formats supported by the hardware video accelerator 300. For example, the decoder module 306 may be used, in conjunction with other components of the hardware video accelerator 300 such as the motion estimation module 310 and/or the entropy processing module 308, to perform H.264 decoding.

The entropy processing module 308 may comprise suitable logic, circuitry, interfaces and/or code that may be operable to perform entropy compression/decompression in the hardware video accelerator 300. In this regard, entropy processing may be used to provide lossless compression based on mapping quantized coefficients and/or symbols used by in some video codec compression formats, such as H.264 for example, with corresponding compressed bit streams transmitted and/or received. The entropy processing module 308 may be operable to perform, for example, context-adaptive binary arithmetic coding (CABAC) and/or context-adaptive variable-length coding (CAVLC) processing. In this regard, CABAC processing may be used to support H.264 Main (and higher) profiles, whereas CAVLC, which may perform less efficient entropy compression, may be used for other profiles, such as the H.264 Baseline profile.

The motion estimation module 310 may comprise suitable logic, circuitry, interfaces and/or code that may be operable to perform motion estimation processing to support motion compensation based compression formats, such as H.264/MPEG-4 AVC for example. Use of motion compensation enable predictive encoding/decoding of images (full frames in progressive video or top/bottom fields in interlaced video), or parts thereof. Exemplary use of predictive encoding/decoding is the use of I-frames, B-frames, and/or P-frames in MPEG based formatted video data. In older motion compensation based compression schemes, full frames (or fields) are utilized. In H.264/MPEG-4 AVC video codec based processing, however, the level of predictive processing may be further enhanced based on a lower level of representation called slice. In this regard, a slice may comprise a spatially distinct region of a image that is encoded separately from any other region in the same image. Accordingly, H.264/MPEG-4 AVC encoding/decoding utilizes I-slices, P-slices, and/or B-slices. The motion estimation processing performed by the motion estimation module 310 may enable generating motion vectors for a picture (a full frame in progressive video or a field in interlaced video), or parts thereof. The motion vectors may be used to provide inter-frame prediction—i.e., predicting a current image, or parts thereof, based on one or more reference images. In this regard, motion vectors may describe transformation from the reference images to the image being encoded or decoded.

In an exemplary aspect of the invention, the motion estimation module 310 may comprise two distinct steps, performed by the CME module 312 and the FME module 314. The motion estimation module 310 may also comprise an internal buffer 316, which may be used to cache video data corresponding to a current image being encoded via the hardware video accelerator 300, and/or one or more reference images which may be utilized during, for example, motion estimation processing. While the buffer 316 is shown herein as sub-component of the FME module 314, the invention needs no be so limited.

The CME module 312 may comprise suitable logic, circuitry, interfaces and/or code that may be operable to perform coarse motion estimation, which may be one of the initial stages of video encoding. In this regard, coarse motion estimation may be performed on half resolution (e.g. YUV 4:2:0) images corresponding to a current frame, and/or one or more reference frames. During coarse motion estimation, whole macroblocks (e.g. 8×8 pixels) may be considered to determine motion vector for each macroblock which may provide lowest sum of absolute differences (SAD). In this regard, the CME module 312 may determine a sum of absolute differences between each reference and current macroblock (including luminance and chrominance), and keep track of the best match for finding the lowest SAD. The CME module 312 may operate on individual frames. The CME module 312 may also be configured for operation on portions of blocks, for backward compatibility for example. To reduce external memory access bandwidth, the CME module 312 may comprise sufficient internal cache to store all the reference window for sixteen (4×4) macroblocks at once, and may search all the buffered macroblocks before moving the reference window. Alternatively, the video data may be stored in the buffer 316.

The FME module 314 may comprise suitable logic, circuitry, interfaces and/or code that may be operable to fine motion estimation. In this regard, fine motion estimation processing may constitute the second stage of motion estimation, and may be performed and/or used during video encoding to determine motion vectors to achieve, for example, half-pel or quarter-pel accuracy. The FME module 314 may provide, for each macroblock, a plurality of candidate motion vectors corresponding to a plurality of reference images. The block contains three principal functional units, which are grouped together as they share large amounts of state. This may be particular true for a memory which contains sum of average difference (SAD) values and motion vectors for macroblock partitions.

In operation, the hardware video accelerator 300 may be used to perform, for example, H.264/MPEG-4 AVC video encoding. In this regard, video data which is to be encoded may be stored in, and retrieved from the external memory 320. In H.264 encoding, motion estimation may be first performed, to generate motion vectors for each macroblock for example, and macroblock encoding may then be performed. In this regard, during motion estimation processing, via the motion estimation module 310, the video data to be encoded may be retrieved from the external memory 320, and may be cached in the buffer 316. Coarse motion estimation may first be performed by the CME module 312. This may allow generation of high-level motion estimation information regarding the vector motion for a current macroblock. Fine motion estimation may then performed, via the FME module 314, to refine motion estimation information and/or vectors generated during the coarse motion estimation processing.

In this regard, fine motion estimation may comprise searching possible candidate positions, generated during coarse motion estimation processing for example, to refine two candidate motion vectors from double-pel to quarter-pel precision. The final motion vector may then be generated, via the FME module 314, based on the determined best match. In this regard, a motion vector may define (predict) shifting in a position of one or more objects, in terms of pixels and portions of pixels, between of the current frame and one or more reference frames. After motion estimation is complete, macroblock encoding may be performed, via the encoder 304 for example, In this regard, rather than re-fetching the video data from the external memory 320, thus consuming more memory access bandwidth, the previously loaded video data, cached in the buffer 316, may be used during the macroblock encoding.

The macroblock encoding may only be applied to a residual, which may correspond to the difference between the original video data (for the whole frame or slice) and prediction information generated based on motion estimation, pertaining to parts of the frame that may predicted based on reference frames (or parts/slices thereof). Once the residual is determined, the encoder 304 may transform the residual to frequency space based quantization—i.e. codes corresponding to the residual, which may further be subjected to entropy compression via the entropy processing module 308, to generate the finalized compressed bit stream corresponding to the video data. While the encoder 304 and the decoder 306 are shown as separate components, because video encoding/decoding share many common steps and/or operations, the encoder 304 and the decoder 306 may share components and/or sub-modules. In this regard, the VCE module 302 may control scheduling use of any such common components during concurrent video encoding and decoding processing via the hardware video accelerator 300.

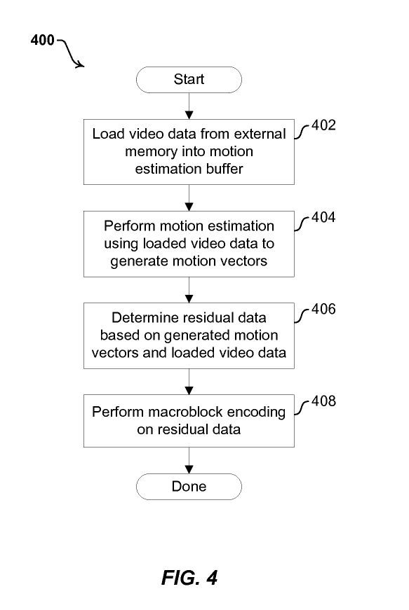

FIG. 4 is a flow chart that illustrates exemplary steps for bandwidth reduction through integration of motion estimation and macroblock encoding, in accordance with an embodiment of the invention. Referring to FIG. 4, there is shown a flow chart 400 comprising a plurality of exemplary steps that may be performed to enable bandwidth reduction through integration of motion estimation and macroblock encoding.

In step 402, video data may be loaded from external memory into motion estimation buffer. For example, video data corresponding to a current image and/or one or more reference images may be loaded into the buffer 316 in the hardware video accelerator 300 from the external memory 320. In step 404, motion estimation may be performed using fetched video data, to generate motion estimation related information, which may comprise motion vectors. For example, the motion estimation module 310 may generate motion vectors corresponding to a current macroblock, using corresponding video data cached in the buffer 316. In this regard, motion estimation processing may comprise initially performing coarse motion estimation, via the CME module 312, and subsequently performing fine motion estimation, via the FME module 314, substantially as described with regard to, for example, FIG. 3.

In step 406, residual data for the current macroblock may be determined based on generated motion vectors and video data previously loaded for motion estimation. For example, the residual data for the current macroblock, for which motion vectors were generated via the motion estimation 310, may be determined based on original video data corresponding to the current macroblock, which may still be cashed in the buffer 216, and the corresponding motion vectors. In step 408, macroblock encoding may be performed for the current macroblock based on the determined residual data and/or the corresponding motion vectors.

Various embodiments of the invention may comprise a method and system for bandwidth reduction through integration of motion estimation and macroblock encoding. The hardware video accelerator 300, which may support one or more motion-compensation based video encoding and/or decoding, such as H.264/MPEG-4 AVC compression, may support reducing external memory access bandwidth during video encoding. In this regard, video data corresponding to a current frame and a plurality of reference frames may be loaded into the hardware video accelerator 300 from the external memory 320, and the loaded video data may be cached in the buffer 316, which may be used to support motion estimation processing via the motion estimation module 310. The motion estimation may be initially performed for the current frame using video data loaded into the buffer 316, and after completion of the motion estimation, macroblock encoding for the current frame may be performed using the video data cached in the buffer 316 and output(s) of the motion estimation, without necessitating accessing the external memory 320. In this regard, the motion estimation may comprise performing both coarse motion estimation (CME), via the CME module 312, and fine motion estimation (FME), via the FME module 314. Furthermore, motion vectors may be generated based on the motion estimation processing in the motion estimation module 310, on per-macroblock basis for example. The macroblock encoding may comprise macroblock encoding of a residual of the current frame, wherein the residual may be determined based on the original video data, accessed from the internal buffer 316, and prediction information determined based on the generated motion vectors. In this regard, the residual may be generated by subtracting from the original video data corresponding to the current frame, the prediction that is generated based on the motion vectors that are estimated using the motion estimation. The hardware video accelerator 300 may support, in addition to H.264/MPEG-4 encoding/decoding, video encoding and/or decoding based on VC-1, MPEG-1, MPEG-2, MPEG-4 and/or AVS standards. Furthermore, the hardware video accelerator 300 may perform video encoding and/or decoding based on one or more legacy video compression standards, comprising, for example, On2 VP6/VP7 and/or H.263 standards.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for bandwidth reduction through integration of motion estimation and macroblock encoding.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
in a video processing device that processes a plurality of video frames:
estimating motion associated with a current one of said plurality of video frames utilizing motion estimation based on video data corresponding to said current one of said plurality of video frames and one or more reference frames;
and
macroblock encoding said current one of said plurality of video frames based on said estimated motion, wherein said video data is loaded from a memory once for said motion estimation and said macroblock encoding.

2. The method according to claim 1, comprising buffering said video data in an internal buffer used during said motion estimation.

3. The method according to claim 2, wherein said internal motion estimation buffer is accessible during said macroblock encoding.

4. The method according to claim 1, comprising performing coarse motion estimation and fine motion estimation during said motion estimation.

5. The method according to claim 1, comprising generating motion vectors based on said motion estimation.

6. The method according to claim 1, wherein said macroblock encoding comprises macroblock encoding a residual of said current one of said plurality of video frames, said residual comprising parts of said current one of said plurality of video frames not predictable based on said motion estimation.

7. The method according to claim 6, comprising generating said residual by subtracting predicted motion vectors generated based on said motion estimation from original video data corresponding to said current one of said plurality of video frames.

8. The method according to claim 1, comprising performing said motion estimation and/or said macroblock encoding based on H.264/AVC standard.

9. The method according to claim 8, wherein said video processing device is operable to perform video encoding and/or decoding based on VC-1, MPEG-1, MPEG-2, MPEG-4 and/or AVS standards.

10. The method according to claim 8, wherein said video processing device is operable to perform video encoding and/or decoding based on legacy video compression standards, said legacy video compression standards comprising On2 VP7 and/or H.263 standards.

11. A system for video processing, the system comprising:
one or more circuits and/or processors in a video processing device that processes a plurality of video frames, said one or more circuits and/or processors are operable to:
estimate motion associated with a current one of said plurality of video frames utilizing motion estimation based on video data corresponding to said current one of said plurality of video frames and one or more reference frames; and
macroblock encode said current one of said plurality of video frames based on said estimated motion, wherein said video data is loaded from a memory once for said motion estimation and said macroblock encoding.

12. The system according to claim 11, wherein said one or more circuits and/or processors are operable to buffer said video data in an internal buffer used during said motion estimation.

13. The system according to claim 12, wherein said internal motion estimation buffer is accessible during said macroblock encoding.

14. The system according to claim 11, wherein said one or more circuits and/or processors are operable to perform coarse motion estimation and fine motion estimation during said motion estimation.

15. The system according to claim 11, wherein said one or more circuits and/or processors are operable to generate motion vectors based on said motion estimation.

16. The system according to claim 11, wherein said macroblock encoding comprises macroblock encoding a residual of said current one of said plurality of video frames, said residual comprising parts of said current one of said plurality of video frames not predictable based on said motion estimation.

17. The system according to claim 16, wherein said one or more circuits and/or processors are operable to generate said residual by subtracting predicted motion vectors generated based on said motion estimation from original video data corresponding to said current one of said plurality of video frames.

18. The system according to claim 11, wherein said one or more circuits and/or processors are operable to perform said motion estimation and/or said macroblock encoding based on H.264/AVC standard.

19. The system according to claim 18, wherein said video processing device is operable to perform video encoding and/or decoding based on VC-1, MPEG-1, MPEG-2, MPEG-4 and/or AVS standards.

20. The system according to claim 18, wherein said video processing device is operable to perform video encoding and/or decoding based on legacy video compression standards, said legacy video compression standards comprising On2 VP7 and/or H.263 standards.
